(19) United States
(12) Patent Application Publication
(10) Pub. No.: US 2010/0067239 A1
(43) Pub. Date: Mar. 18, 2010

(54) Lamp shape structure

(75) Inventor: Tsan-Jung Chen, Sanchong City (TW)

Correspondence Address: BACON & THOMAS, PLLC, 625 SLATERS LANE, FOURTH FLOOR, ALEXANDRIA, VA, 22314-1176, US

(73) Assignee: KOCAM INTERNATIONAL CO., LTD., Sanchong City (TW)

(21) Appl. No.: 12/461,975

(22) Filed: Aug. 31, 2009

(30) Foreign Application Priority Data
Sep. 16, 2008 (TW) 097216690

(51) Int. Cl. F21V 7/00

(52) U.S. Cl. 362/341

(57) ABSTRACT

A lamp shade structure applied to a liquid crystal display backlight module includes a metal hood, an adhesive layer and a reflective sheet, wherein the metal hood is formed by bending a metal sheet into a cross-sectional shape and has a containing space formed at an internal side of the metal hood, the cross-section of the reflective sheet is in an arc shape, and a side of the reflective sheet is attached to the containing space through the adhesive layer. Since the cross-section of the reflective sheet is in an arc shape, therefore the present invention can improve the reflecting efficiency of the lamp shade structure effectively.

### FIELD OF THE INVENTION

The present invention relates to a lamp shade, more particularly to a lamp shade structure applied to a liquid crystal display (LCD) backlight module and including a reflective sheet with an arc-shaped cross-section for increasing reflecting efficiency of the lamp shade.

### BACKGROUND OF THE INVENTION

Conventional display products (such as televisions and monitors, etc) generally use a cathode ray tube (CRT) to achieve the display effect, however, the conventional CRT display devices are usually existing the problems of having large volume, heavy weight and power-consuming. As high technologies keeping on advancing, the conventional way of manufacturing display products by using CRT is gradually replaced by liquid crystal display (LCD) panel under the reasons that LCD panel products (including televisions, monitors, and notebook computers, etc) are lighter, thinner, shorter and smaller than the conventional CRT products, such that users can move the LCD products easily and no longer need to reserve large space for putting the conventional CRT products, so as to improve the space utilization effectively. In the recent years, the LCD products gradually become favorable products to individuals and companies and are now extensively used in our daily life and work.

In a general display method of LCD panels, light is entered from the rear side of a LCD panel into a liquid crystal layer thereof and transmitted through the liquid crystal in the liquid crystal layer, since the liquid crystal is a non-luminescent material, so that the LCD panel requires a backlight module to project the light from the rear side to the front side of the LCD panel so as to provide a light source with sufficient brightness and uniform distribution for displaying images normally. Therefore, a lamp shade designed for the backlight module becomes a determinant factor of the quality of the LCD panels.

Stamping and molding are generally used in the manufacturing process of a lamp shade. With reference to FIG. 1, an operator places a workpiece 1 of the lamp shade on the top of a bending platform 20 of a stamp machine 2 and turns on the stamp machine 2, so that a shaping device 21 of the stamp machine is moved towards the bending platform 20 to stamp the workpiece 1 into a required cross-sectional shape. In FIG. 1, the workpiece 1 is formed by combining a metal sheet 10, an adhesive layer 12 and a reflective sheet 14 together, wherein the reflective sheet 14 is made of a plastic material which is a white foam polyethylene terephthalate (PET) material, or a layer of light-reflective coating coated with the transparent PET material on a side for reflecting a light source. In the description below, a reflective sheet 14 made of the transparent PET material plus the light-reflective coating is used for illustrating the invention. A side of the metal sheet 10 is coupled to another side of the reflective sheet 14 without the light-reflective coating through the adhesive layer 12, so that manufacturers can produce a lamp shade product by performing the stamping and molding process to the workpiece 1.

Since the metal sheet 10 comes with a specific hardness greater than the hardness of the reflective sheet 14, therefore it is necessary to apply a larger force to the shaping device 21 to bend the metal sheet 10 into a required cross-sectional shape during the process of stamping and molding the workpiece 1 in order to stamp the workpiece 1 into a predetermined cross-sectional shape as shown in FIGS. 1 and 2. In the process of bending the metal sheet 10, a force (as indicated by the arrow B of FIG. 2) of the shaping device 21 is exerted onto a bent position (as indicated by the dotted circle A in FIG. 2) of the reflective sheet 14, and a deformation may occur at the bent position of the reflective sheet 14 due to a deformation stress (as indicated the arrow C of FIG. 2) produced at the bent position of the metal sheet 10, such that the bent position becomes thinner. If the lamp shade is applied to an LCD backlight module, light will pass through the bent position of the reflective sheet 14 easily, and the overall reflecting efficiency of the lamp shade will be decreased. In addition, when the deformation occurs at the bent position of the reflective sheet 14, the surface at the bent position or near the bent position will be pressed or extended, such that the light-reflective coating on the reflective sheet 14 will become uneven or damaged, and the uneven or damaged light-reflective coating will affect the reflecting efficiency of the lamp shade adversely.

In general, the metal sheet 10 must be stamped according to the shape of a casing of an LCD product so as to fit the casing and successfully be assembled into the LCD product. In the above conventional manufacturing process, since the metal sheet 10 is integrated with the adhesive layer 12 and the reflective sheet 14 to form the workpiece 1, the reflective sheet 14 together with the metal sheet 10 and the adhesive layer 12 are stamped into the same shape during the stamping process of the lamp shade. Although the process of stamping the workpiece 1 including the metal sheet 10, the adhesive layer 12 and the reflective sheet 14 simultaneously can give rise to a better production efficiency, yet such stamping method cannot stamp the reflective sheet 14 with a smooth arc cross-sectional shape, so that the reflecting efficiency of the reflective sheet 14 and the quality of the lamp shade will be decreased significantly.

In summation of the description above, since the metal sheet 10, the adhesive layer 12 and the reflective sheet 14 are included in the conventional workpiece 1, and the metal sheet 10 and the reflective sheet 14 are stamped simultaneously according to the shape of the casing, it is difficult to stamp the reflective sheet 14 with a smooth arc cross-sectional shape. Besides, when the lamp shade is stamped into a cross-sectional shape with many bends, the thickness of the reflective sheet 14 will become uneven, and many thinner spots will result and cause an increased defective rate of the LCD products that adopt the conventional lamp shade structure. Obviously, it is an important subject for lamp shade designers and manufacturers to design and develop a novel lamp shade structure to overcome the aforementioned problems.

### SUMMARY OF THE INVENTION

In view of the foregoing shortcomings of the conventional lamp shade structure having a smaller thickness occurred at bent positions of a reflective sheet after a stamping and molding process takes place and affecting the reflecting efficiency of the lamp shade adversely, as well as having the difficulty of stamping the reflective sheet with a smooth arc cross-sectional shape, the inventor of the present invention based on years of experience in the related industry to conduct extensive researches and experiments, and finally designed and developed a lamp shade structure in accordance with the present invention to overcome the aforementioned shortcomings, and the invention can increase the reflecting efficiency and the quality of the LCD of the lamp shade structure.

Therefore, it is a primary objective of the present invention to provide a lamp shade structure comprising a metal hood, an adhesive layer and a reflective sheet, and the lamp shade structure is applied to a liquid crystal display (LCD) backlight module, wherein after the metal hood is bent, a containing space is formed at an internal side of the metal hood, and the adhesive layer has an adhesiveness and is disposed between the metal hood and the reflective sheet, and the cross-section of the reflective sheet is substantially an arc shape, such that the reflective sheet can be attached in the containing space by the adhesiveness of the adhesive layer. Since the cross-section of the reflective sheet is in an arc shape, therefore the reflecting efficiency of the lamp shade structure can be improved effectively.

Another objective of the present invention is to avoid stamping the workpiece composed of the metal sheet, adhesive layer and reflective sheet since the cross-section of the reflective sheet is in an arc shape, and the adhesive layer is attached to the bent metal hood, and thus the invention can prevent the thickness of the bent position from becoming thinner due to a deformation formed at the bent position after the reflective sheet is stamped and molded. Therefore, the present invention can improve the uneven thickness occurred at each position of the reflective sheet of the lamp shade produced by the conventional molding process, so as to increase the reflecting efficiency of the lamp shade structure.

A further objective of the present invention is to provide a protecting film on a side of the reflective sheet opposite to the metal hood, so as to prevent any unintentional scratch to the reflective sheet while the molded lamp shade structure is being transported, and reduce the chance of having a low reflecting efficiency of the lamp shade structure, and extend the using life of the lamp shade structure effectively.

### BRIEF DESCRIPTION OF THE DRAWINGS

FIG. 1 is a schematic view of manufacturing a conventional lamp shade;

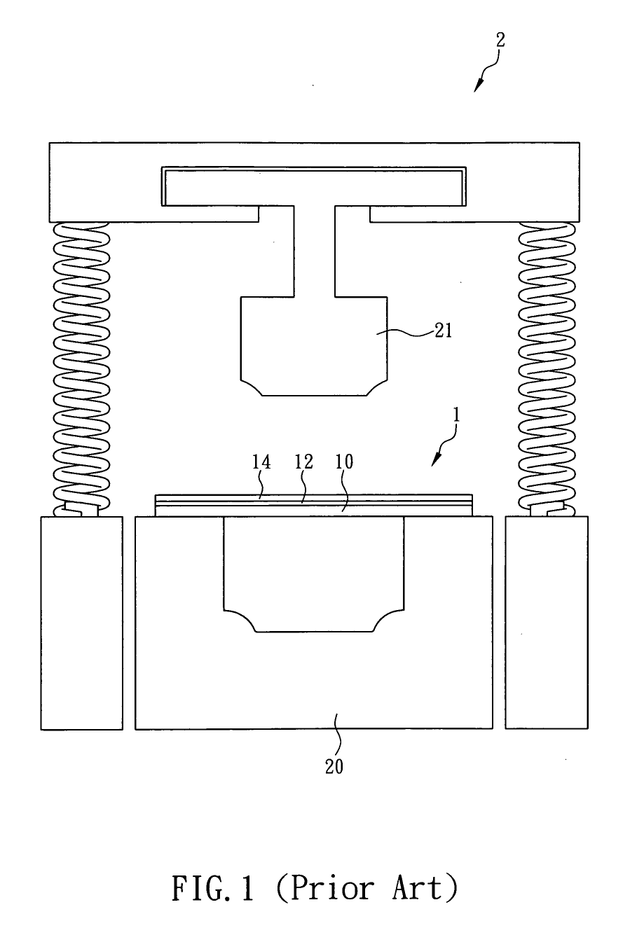

FIG. 2 is a schematic view of a molded conventional lamp shade;

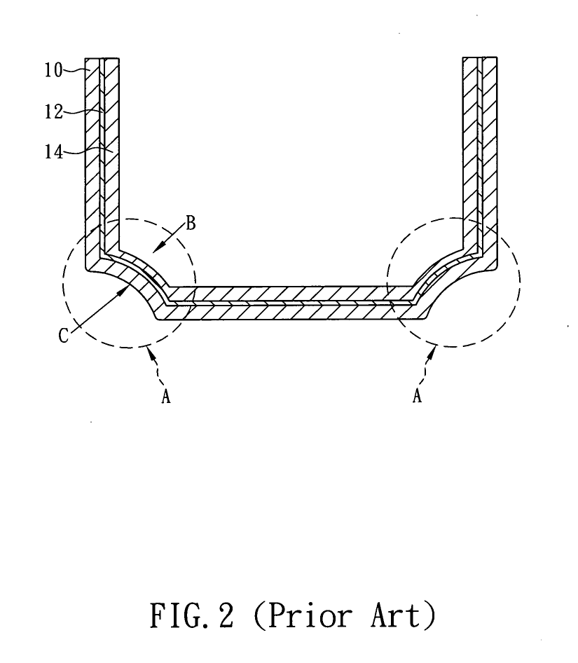

FIG. 3 is an exploded view of a lamp shade structure in accordance with a preferred embodiment of the present invention; and

FIG. 4 is a schematic view of a lamp shade structure in accordance with another preferred embodiment of the present invention.

### DETAILED DESCRIPTION OF THE PREFERRED EMBODIMENTS

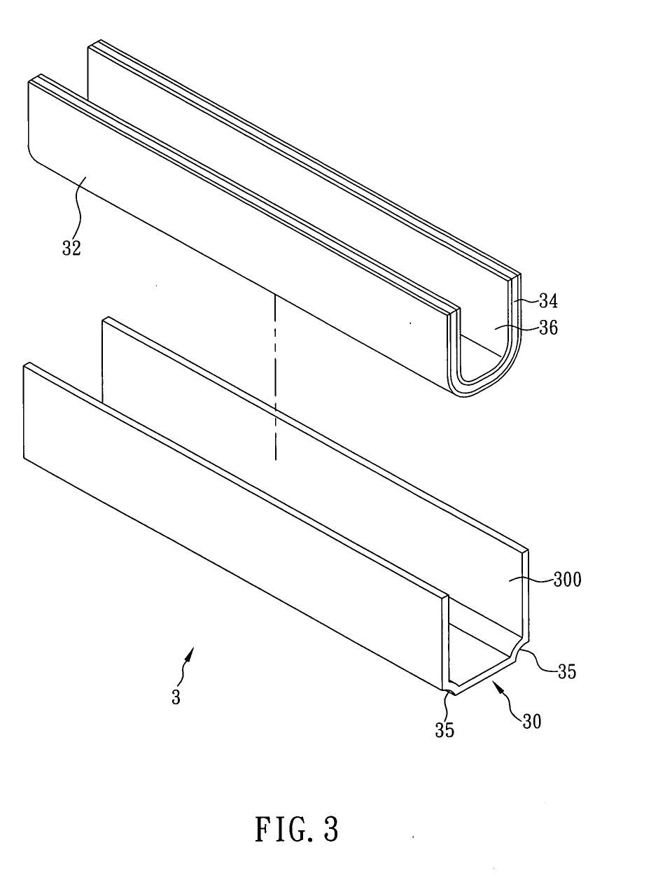

With reference to FIG. 3 for a liquid crystal display (LCD) lamp shade structure applied to an LCD backlight module, the lamp shade structure 3 comprises a metal hood 30, an adhesive layer 32 and a reflective sheet 34, wherein the metal hood 30 is formed by bending a metal sheet with a cross-sectional shape, and the cross-sectional shape of a reflective sheet 34 is substantially an arc shape, and the adhesive layer 32 is attached between the metal hood 30 and the reflective sheet 34 for sticking the metal hood 30 and the reflective sheet 34 together to form the lamp shade structure 3.

In a preferred embodiment of the present invention as shown in FIG. 3, a lamp shade structure 3 comprises a metal hood 30, an adhesive layer 32 and a reflective sheet 34, wherein the metal hood 30 is formed by bending a stamped metal sheet into a cross-sectional shape according to the shape of a casing (not shown in the figure) of an LCD required to be installed to the lamp shade structure 3. In this preferred embodiment, the metal hood 30 is stamped into a form as shown in FIG. 3, wherein a containing space 300 is formed at an internal side of the metal hold 30 after the stamping process takes place, and the cross-sectional shape of the metal hood 30 so formed has a plurality of bent portions 35 matched with the shape of the casing, and the cross-section of the reflective sheet 34 is formed into an arc shape by another molding procedure, and manufacturers can coat the adhesive layer 32 onto the arc surface at an external surface of the reflective sheet 34, and the reflective sheet 34 coated with the adhesive layer 32 is placed into the containing space 30 and stuck in the containing space 300 by the adhesive layer 32 to form the lamp shade structure 3 with a smooth arc cross-sectional shape in accordance with the present invention to achieve the effects of increasing the reflecting efficiency of the lamp shade structure 3 and the quality of the LCD that adopts the lamp shade structure 3.

Since the reflective sheet 34 is formed with an arc cross-sectional shape in advance, and the adhesive layer 32 is stuck with the bent and molded metal hood 30, therefore the invention can avoid stamping the metal hood 30, the adhesive layer 32 and the reflective sheet 34 simultaneously and can also prevent the thickness at the bent position of the stamped and molded reflective sheet 34 from becoming smaller due to the deformation occurred at the bent position. Therefore, the invention can overcome the issue of having an uneven thickness of the reflective sheet of the conventional stamped and molded lamp shade to increase the reflecting efficiency of the lamp shade structure 3.

In the preferred embodiment as shown in FIG. 3, the reflective sheet 34 is made of a plastic material with is a white foam saturated polyethylene terephthalate (PET) or a PET material coated with a light-reflective coating on a side to provide the effect of reflecting a light source, and the reflective sheet 34 has a protecting film 36 disposed on a surface opposite to the metal hood 30 to prevent possible scratches occurred to the light-reflective coating of the reflective sheet 34 during the transportation of the lamp shade structure 3 and also avoid resulting in a poor reflecting efficiency of the lamp shade structure 3. The invention not only assures the quality of the lamp shade structure 3, but also extends the using life of the lamp shade structure 3 significantly and maintains a high reflecting efficiency of the lamp shade structure 3.

It is noteworthy to point out that the adhesive layer 32 of the preferred embodiment is made of a double-sided adhesive material, a hot melt adhesive material, or any adhesive material capable of sticking the metal hood 30 and the reflective sheet 34 together. The aforementioned procedure of coating the adhesive layer 32 onto an external arc surface of the reflective sheet 34, putting the reflective sheet 34 coated with the adhesive layer 32 into the containing space 300, and sticking the reflective sheet 34 into the containing space 300 through the adhesive layer 32 can be modified according to the actual requirements of the manufacturing procedure of the lamp shade structure 3. For example, the adhesive layer 32 is coated into the containing space 300 first, and then the reflective sheet 34 is placed into the containing space 300 coated with the adhesive layer 32 to stick the reflective sheet 34 into the containing space 300 through the adhesive layer 32 to form the lamp shade structure 3 of the present invention.

In the preferred embodiment as shown in FIG. 3, the procedure of sticking the metal hood 30 and the reflective sheet 34 together is achieved manually or by a press machine (not shown in the figure), so that the metal hood 30 and the reflective sheet 34 are stuck tightly with one another, and the adhesive layer 32 can secure the metal hood 30 and the reflective sheet 34 to form the lamp shade structure 3, so as to prevent the metal hood 30 and the reflective sheet 34 from being separated from one another due to a shock or vibration of the lamp shade structure 3 and extend the using life of the lamp shade structure 3 effectively.

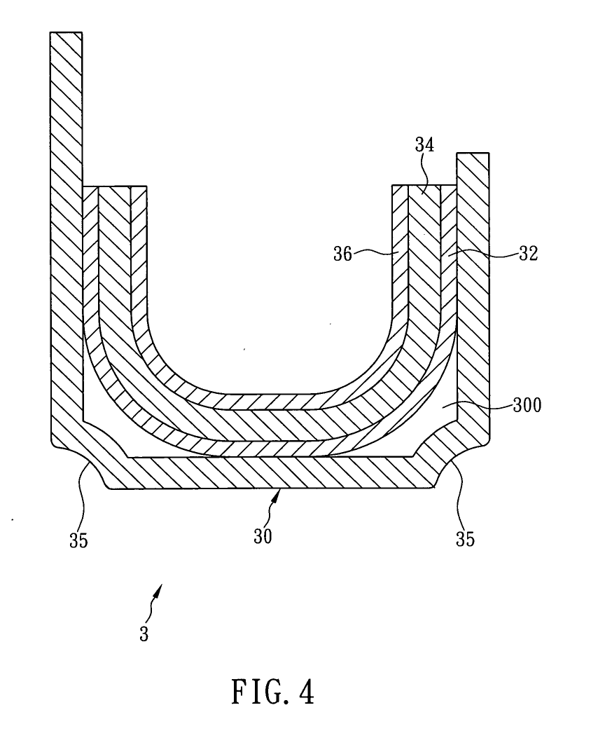

In the preferred embodiment, the edge of the metal hood 30 and the edge of the reflective sheet 34 are not limited to be equidistantly arranged only, but the design of the length between the edge of the metal hood 30 and the edge of the reflective sheet 34 of the lamp shade structure 3 can be modified according to the actual manufacturing requirements. With reference to FIG. 4 for another preferred embodiment of the present invention, a predetermined distance is designed between the edge of the metal hood 30 and the edge of the reflective sheet 34, so that manufacturers can design the metal hood 30 and the reflective sheet 34 to fit the casing of the LCD according to the actual manufacturing requirements, and the lamp shade structure 3 can comply with a commercial application.

In summation of the description above, the lamp shade structure 3 of the present invention has the following advantages:

1. Since the cross-section of the reflective sheet 34 is in an arc shape, therefore the reflecting efficiency of the lamp shade structure 3 can be increased effectively.

2. Since the cross-section shape of the reflective sheet 34 is formed into an arc shape in advance, and the adhesive layer 32 is stuck with the bent and molded metal hood 30, therefore the invention can avoid stamping the metal hood 30, the adhesive layer 32 and the reflective sheet 34 simultaneously, and can also prevent the result of having deformations occurred at the bent position of the stamped and molded reflective sheet 34.

3. The protecting film 36 of the reflective sheet 34 assures the quality of the lamp shade structure 3 effectively and extends the using life of the lamp shade structure 3 significantly.

While the invention has been described by means of specific embodiments, numerous modifications and variations could be made thereto by those skilled in the art without departing from the scope and spirit of the invention set forth in the claims.

What is claimed is:

1. A lamp shade structure, applied to a light crystal display (LCD) backlight module, and the lamp shade structure comprising:
a metal hood, formed by bending a metal sheet into a cross-sectional shape having a containing space formed at an internal side of the metal hood;
a reflective sheet, having a cross-section substantially in an arc shape; and
an adhesive layer, attached between a surface of the metal hood facing the containing space and the reflective sheet, for sticking the metal hood and the reflective sheet together.

2. The lamp shade structure of claim 1, wherein an edge of the metal hood is apart from an edge of the reflective sheet with a predetermined distance.

3. The lamp shade structure of claim 1, wherein the cross-section of the metal sheet includes a plurality of bent portions.

4. The lamp shade structure of claim 1, wherein the reflective sheet includes a protecting film disposed on a side opposite to the metal hood.

5. The lamp shade structure of claim 2, wherein the reflective sheet includes a protecting film disposed on a side opposite to the metal hood.

6. The lamp shade structure of claim 3, wherein the reflective sheet includes a protecting film disposed on a side opposite to the metal hood.
